(19) United States
(12) Patent Application Publication
(10) Pub. No.: US 2003/0144893 A1
(43) Pub. Date: Jul. 31, 2003

(54) Schedule management method, program and record medium

(75) Inventors: Yukinori Kawabata, Kawasaki (JP); Kiyokazu Hanatani, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/119,896

(22) Filed: Apr. 11, 2002

(30) Foreign Application Priority Data
Jan. 31, 2002 (JP) 2002-023387

(51) Int. Cl. G06F 17/60

(52) U.S. Cl. 705/8

(57) ABSTRACT

An attendance request acceptance step includes accepting an event attendance request, by displaying an attendance request entry screen having scheduling tables of register type with request selection boxes of persons requested to attend, in response to access from a user, and a schedule writing step includes writing the contents of the event in each of the scheduling tables of the persons requested to attend. A notification step includes informing the persons requested to attend of an event attendance request, by sending e-mail. A reply acceptance step includes accepting a reply of the attendance requested persons to the event attendance request, and writing the result of the reply in each of the scheduling tables of the persons requested to attend.

### BACKGROUND OF THE INVENTION

1. Field of the Invention

The present invention relates generally to a schedule management method for scheduling a conference or an event, a program for the schedule management and a record medium on which the schedule management program is stored, and more particularly to a schedule management method for making a request of attendance at a conference or an event on the Web, utilizing a server's function of managing a personal schedule, a program for the schedule management and a record medium having thereon stored the schedule management program.

2. Description of the Related Arts

Generally, when any organization like any group of any type is intending to hold a conference or an event, a host would traditionally make contact with expected attendants by mail or fax, requesting for attendance, whereas, with perfection of communication network environment, in corporate organizations, now they make an attendance request using e-mail provided by a mail server installed at their own intranets.

However, in case of a request of attendance at a conference or an event to be made by e-mail, a person who is requested to attend must send e-mail replying whether being present or absent, whenever he/she receives e-mail requesting for attendance, at much expense in time and effort. Also, when a person who made a request of attendance at a conference or an event cannot receive a reply by the time specified in the mail, the person must re-check whether the person concerned would attend a conference or event or would absent from it, at much expense in time and effort. Further, it has been so far required for a person who receives an attendance request by e-mail to once more enter the conference or the event, at which he/she already replied “present”, in his own scheduling table managed personally.

### SUMMARY OF THE INVENTION

According to the present invention there can be provided a schedule management method that can simply and effectively process attendance request in holding a conference or an event, by means of combination of a schedule management function and an attendance request function, a program for the schedule management and a record medium having stored thereon the schedule management program.

The present invention provides a schedule management method of a server, comprising an attendance request acceptance step which includes accepting an event attendance request, by displaying an attendance request entry screen having scheduling tables of register type with request selection boxes of persons requested to attend, in response to access from a user terminal (client); a schedule writing step which includes writing an event attendance request in each of the scheduling tables of the persons requested to attend; a notification step which includes notifying the persons requested to attend of the event attendance request, by sending e-mail; and a reply acceptance step which includes accepting a reply to the event attendance request from the persons requested to attend and writing the result of the reply in each of the scheduling tables of the persons requested to attend. As described above, according to the present invention, an attendance request can be made easily, with expected persons subject to an attendance request selected from the scheduling table of a register type, by means of, for instance, linking an attendance request function for a conference or an event with a scheduling function provided by a Web server. Also, as the specific schedule for that day of the expected person subject to an attendance request can be known from the scheduling table of a register type, a judgment whether or not to make an attendance request can be made, so that replies to attendance requests can be estimated to a certain extent. Further, when an attendance request is made, the requested event contents will be automatically written in each scheduling table of the attendance requested persons, so that the attendance requested person who replies “present” is no more required to enter into his own scheduling table, and further an attendance request can be surely notified because e-mail requesting for attendance will be sent automatically. In addition, by only clicking of the event attendance request written in his own scheduling table, for instance, the reply entry screen can be displayed, so that the attendance request receiver can easily make a reply on the Web. As the reply result will be reflected into individual scheduling table, the person who made an attendance request can immediately confirm the reply state to the attendance request, by viewing his own scheduling table. Here, the attendance request entry screen to be displayed at the attendance request acceptance step includes a field for specifying a holding date, a field to describe an event and a field to describe mailing comment, in addition to a scheduling table of a register type having a request selection box of the attendance requesting person. Also, when the date of holding an event is entered, the request acceptance step develops a scheduling table corresponding to the entered holding date. The reply acceptance step displays a reply entry screen with reply operation items, in response to the selection operation of the event contents written in the individual scheduling table of the attendance requested persons. The reply acceptance step not only provides reply items of Present, Absent, Hold as reply operation items on the reply entry screen, but also displays the reply result of “unreplied”, “present”, “absent” or “hold” for every attendance requested person.

The present invention provides a program for schedule management. The program allows a computer to execute an attendance request acceptance step which includes accepting an event attendance request, by displaying an attendance request entry screen having scheduling tables of register type with request selection boxes of persons requested to attend, in response to access from a user terminal; a schedule writing step which includes writing an event attendance request in each of the scheduling tables of the persons requested to attend; a notification step which includes notifying the persons requested to attend of the event attendance request, by sending e-mail; and a reply acceptance step which includes accepting a reply to the event attendance request from the persons requested to attend and writing the result of the reply in each of the scheduling tables of the persons requested to attend.

The present invention provides a computer-readable record medium having stored thereon a program for schedule management. This record medium stores thereon a program that allows a computer to execute an attendance request acceptance step which includes accepting an event attendance request, by displaying an attendance request entry screen having scheduling tables of register type with request selection boxes of persons requested to attend, in response to access from a user terminal; a schedule writing step which includes writing an event attendance request in each of the scheduling tables of the persons requested to attend; a notification step which includes notifying the persons requested to attend of the event attendance request, by sending e-mail; and a reply acceptance step which includes accepting a reply to the event attendance request from the persons requested to attend and writing the result of the reply in each of the scheduling tables of the persons requested to attend. Herein, details of the program and the record medium in accordance with the present invention are substantially the same as those of the schedule management method.

The above and other objects, aspects, features and advantages of the present invention will become more apparent from the following detailed description when read in conjunction with the accompanying drawings.

### BRIEF DESCRIPTION OF THE DRAWINGS

FIG. 1 is a block diagram of a system environment, in which schedule management of the present invention is performed;

FIG. 2 is a flowchart of basic processing procedure of schedule management in accordance with the present invention;

FIG. 3 illustrates a scheduling screen with access function of an attendance request;

FIG. 4 illustrates the scheduling screen of a personal register type with the access function of attendance request;

FIG. 5 illustrates an attendance request entry screen displayed at the time when the attendance request is clicked;

FIG. 6 illustrates a scheduling table of a request source, in which an event request is written;

FIG. 7 illustrates a reply entry screen displayed at the time when the event request shown in FIG. 6 is clicked;

FIG. 8 illustrates the scheduling table reflecting the reply;

FIG. 9 illustrates an attendance request entry screen displayed when the attendance request reflecting the reply is clicked; and

FIGS. 10A and 10B are flowcharts of detailed processing procedure of schedule management in accordance with the present invention.

### DETAILED DESCRIPTION OF THE PREFERRED EMBODIMENT

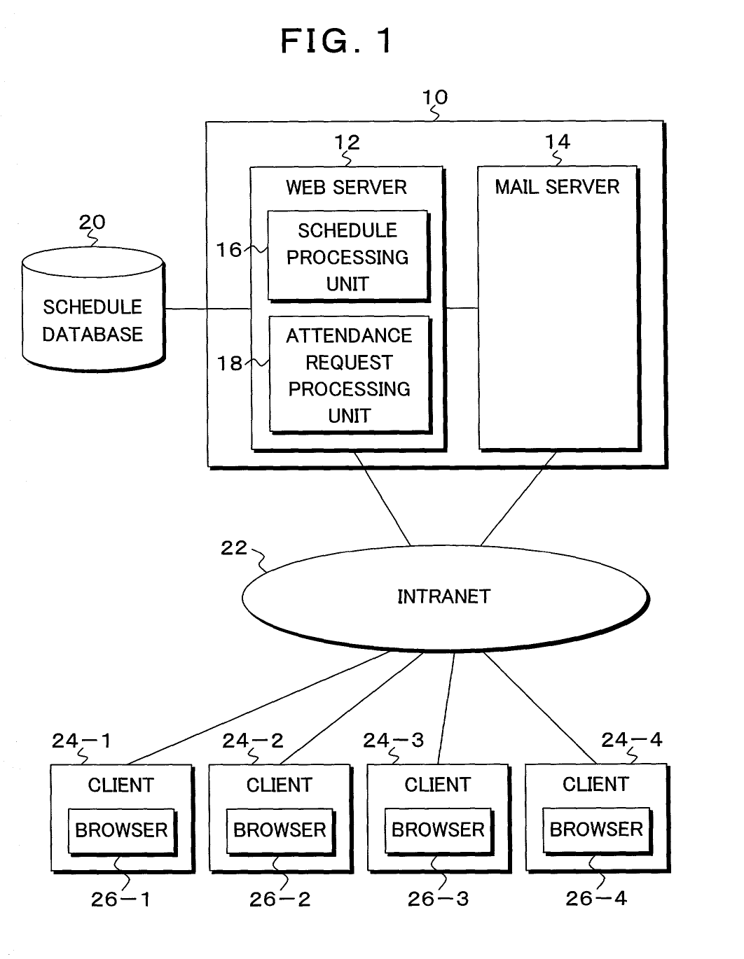

FIG. 1 is a block diagram of a system environment in which schedule management in accordance with the present invention is performed, and takes a server-client system being used at corporate organizations as an example. A server machine 10 has functions of a Web server 12 and a mail server 14. To the Web server 12, a schedule-processing unit 16 is installed, to embody a schedule management function of, for instance, in this embodiment, a member belonging to a certain business department. In accordance with the present invention, to the schedule-processing unit 16, an attendance request-processing unit 18 is installed to make an attendance request to a conference or an event, using a schedule management function. To the schedule-processing unit 16 installed to the Web server 12, a schedule database 20 is installed, and the schedule-processing unit 16 manages this database. For instance, it manages the scheduling table of each member belonging to the business department. To the server machine 10, clients 24-1 through 24-4 are connected through an intranet 22, as user terminals. To the clients 24-1 through 24-4, browsers 26-1 through 26-4 are installed to gain access to the Web server 12. Members belonging to the business department using the clients 24-1 through 24-4 can use a schedule management function by the schedule-processing unit 16 and an attendance request function by the attendance request-processing unit 18 on the Web, by gaining access to the Web server 12 through the browsers 26-1 through 26-4. A mail server 14 installed to the server machine 10 functions as a mailer to mutually send e-mail among the clients 24-1 through 24-4, and further sends e-mail regarding an attendance request automatically, receiving an instruction from a processing function by the attendance request processing unit 18, that is newly installed according to the present invention.

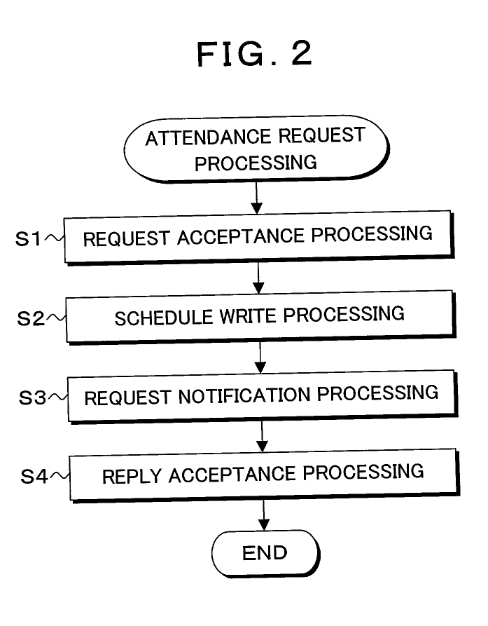

FIG. 2 is a flowchart of basic processing procedure by the attendance request-processing unit 18 installed to the Web server 12 shown in FIG. 1. If, for instance, the user of the client 24-1 clicked the attendance request-processing unit 18 of the Web server 12, using the browser 26-1, request acceptance processing at a step S1 first allows the browser 26-1 of the client 24-1 to display the attendance request entry screen having a scheduling table of register type with the selection box of the person subject to attendance request, and selects the event attendance request. In attendance request by the attendance request entry screen performed by the Web server 12, as the scheduling table of register type with the selection box of the person subject to attendance request is displayed, the requesting destination can be easily selected only by clicking of the selection box of the person subject to attendance request. In schedule writing processing at the next step S2, the accepted event attendance request is written in each scheduling table of the person subject to attendance request, based on the event attendance request by the attendance request entry screen. Next, in request notification processing of a step S3, the accepted event attendance request is automatically informed to the person subject to attendance request, by sending of e-mail. As described above, when writing of an event attendance request into each scheduling table and automatic notification to the persons subject to attendance request by e-mail are finished, reply acceptance processing will be executed at a step S4. This reply acceptance processing accepts replies from the clients 24-1 through 24-4 to the event attendance request of the persons subject to attendance request, and writes the reply result, like Present, Absent or Hold, in each scheduling table of the persons subject to attendance request.

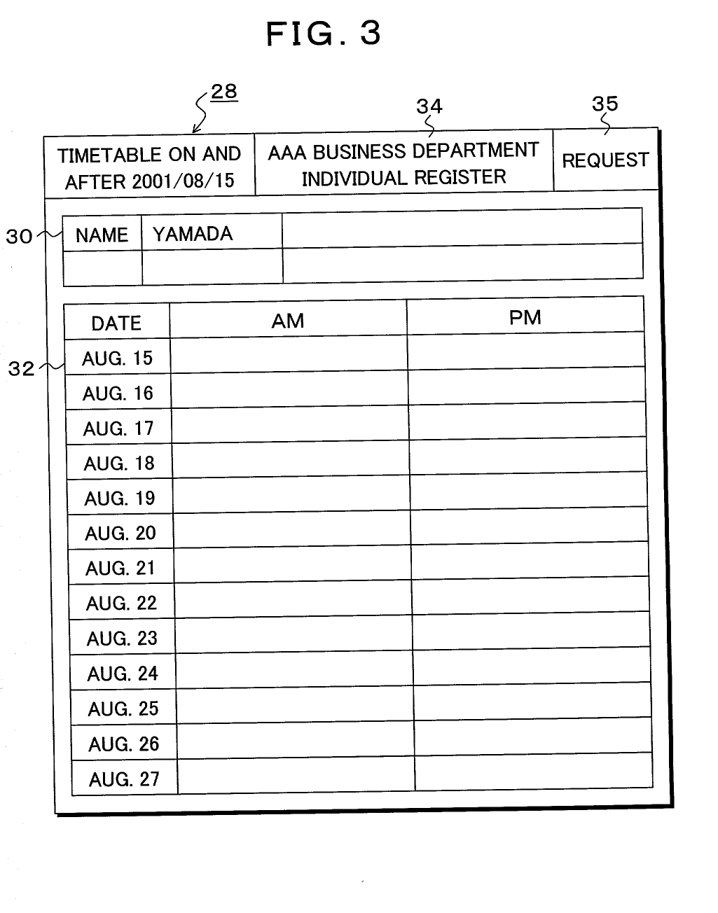

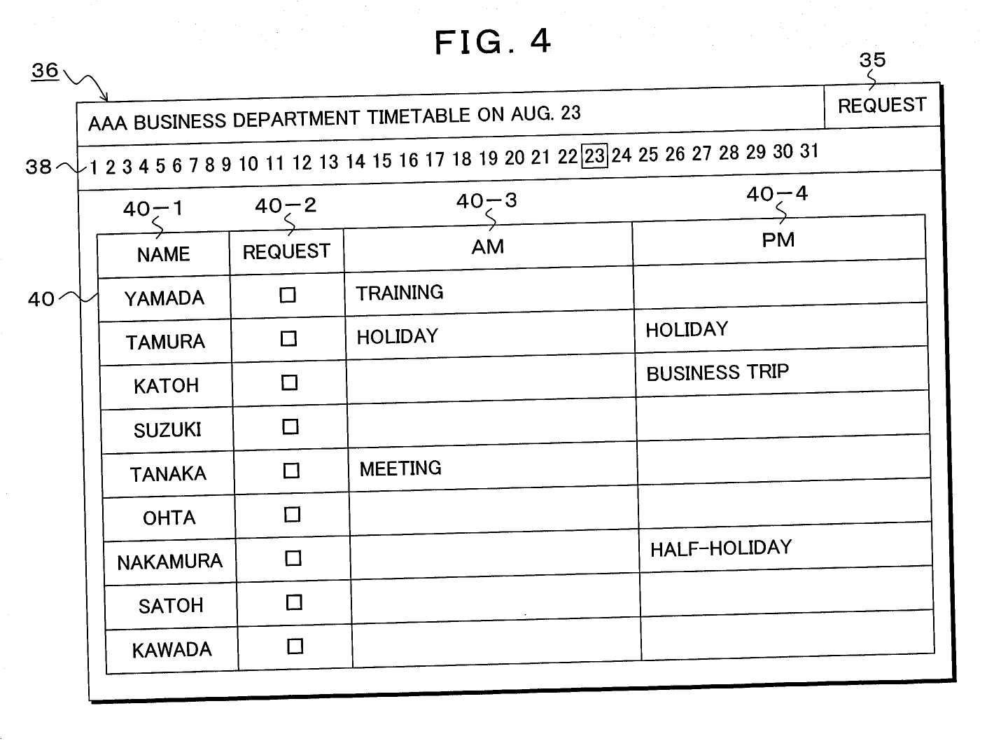

The following describes in detail about attendance request processing in accordance with the present invention indicated by the basic processing procedure shown in FIG. 2, referring to the displayed screen to the browser for schedule management and attendance request. FIG. 3 illustrates a screen to be used as a personal scheduling table by each member of the business department, to be displayed on the side of the clients 24-1 through 24-4. by the schedule processing unit 16 installed to the Web server 12 shown in FIG. 1. The title of this member's scheduling screen is “Timetable from 2001/8/15”, and under the title, a personal information box 30 appears, so that the name of the member using the scheduling table, for instance, “Yamada” is displayed in this box. Under the personal information box 30, a personal scheduling table 32 is displayed. This personal scheduling table 32 gives schedule, for instance, for two weeks from the date of “2001/8/15”, and as to other schedules of before or after the given period, scrolling can display additional schedule. In the personal scheduling table 32, individual schedule can be described separately for AM and PM of each date. On the right-hand upper side of the member-scheduling screen 28, a business department schedule button 34 and an attendance request button 35 are provided. When the business department schedule button 34 is clicked, the screen changes to a business department schedule screen 36 as shown in FIG. 4. On the business department schedule screen 36, “Timetable for AAA Business Department on August 23” is displayed as a title, and under the title, a calendar 38 appears, followed by a scheduling table 40 of a member belonging to the business department is displayed in a register form. This scheduling table 40 of a register type provides a name box 40-1, followed by a request selection box 40-2, that is provided for processing attendance request of the present invention, and further an AM scheduling box 40-3 and an PM scheduling box 40-4. In addition, on the right-hand upper side of the business department schedule screen 36, like the member-schedule screen 28 shown in FIG. 3, an attendance request button 35 is provided. On this business department schedule screen 36, specific schedule of any member belonging to the business department on any specified day and time can be freely checked. As to the scheduling table 40 displayed on the business department schedule screen 36 shown in FIG. 4, when an applicable name given in the name box 40-1 is clicked, the screen changes to the member schedule screen 28 as shown in FIG. 3.

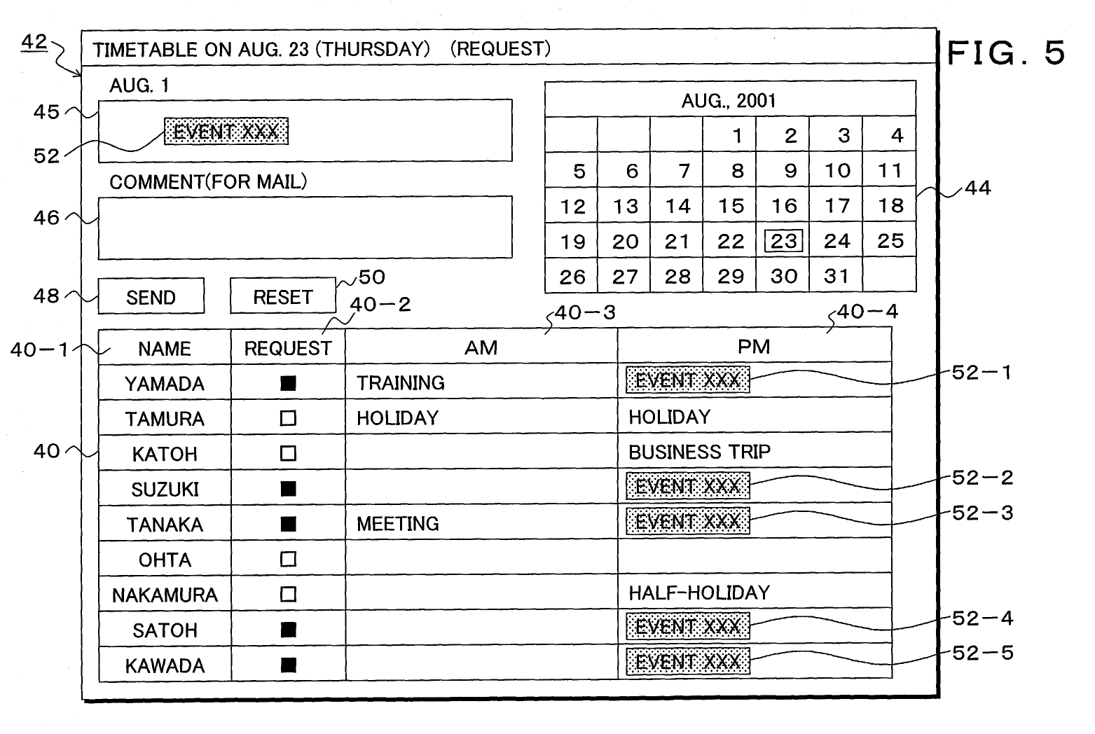

An attendance request on the Web according to the present invention is performed as follows: Now, if “Yamada”, a member of the business department is to make a request for attendance to an event, opening his own member schedule screen 28 as shown in FIG. 3, he is required to click the attendance request button 35 provided on the right-hand upper side of the member schedule screen 28. When the attendance request button 35 is clicked, the screen changes to an attendance request entry screen 42 shown in FIG. 5. This attendance request entry screen 42 has a calendar 44, an event description field 45, a mailing comment field 46, a personal scheduling table 40, a send button 48, and a reset button 50. In order to make an attendance request using the attendance request entry screen 42, the planned date of holding an event, for instance, “August 23” must be first clicked from the calendar 44, then, the contents of schedule for the clicked “August 23” will be displayed in the scheduling table 40. Next, in the event description field 45, an event contents 52, like, for instance, a conference name, conference contents, a conference time period, conference holding place, etc. must be entered. Also, if necessary, comments to the request for attending a conference must be entered in the mailing comment field 46. Then, the host selects person to be requested to attend in the scheduling table 40, and clicks a selection check box of the request selection box 40-2 of the person to be requested to attend. In this example, “Yamada” is to make an attendance request, and 4 members, “Suzuki”, “Tanaka”, “Satoh” and “Kawada” are to receive an attendance request, so, accordingly, “Yamada” must click each check box of the request selection box for each of these four members to reverse to black. As described above, when selection of a candidate member for attendance request is made by clicking of the check box, using of the request selection box 40-2 of the scheduling table 40, the event contents 52 will be automatically written in the scheduling tables of the members requested to attend, and written event contents 52-1 through 52-5 will be displayed. And, when the send button 48 is finally clicked, to the four members, namely, “Suzuki”, “Tanaka”, “Satoh”, and “Kawada”, who are selected in the scheduling table 40 and requested to attend, e-mail including the contents entered in the mailing comment field 46 for attendance request will be automatically sent.

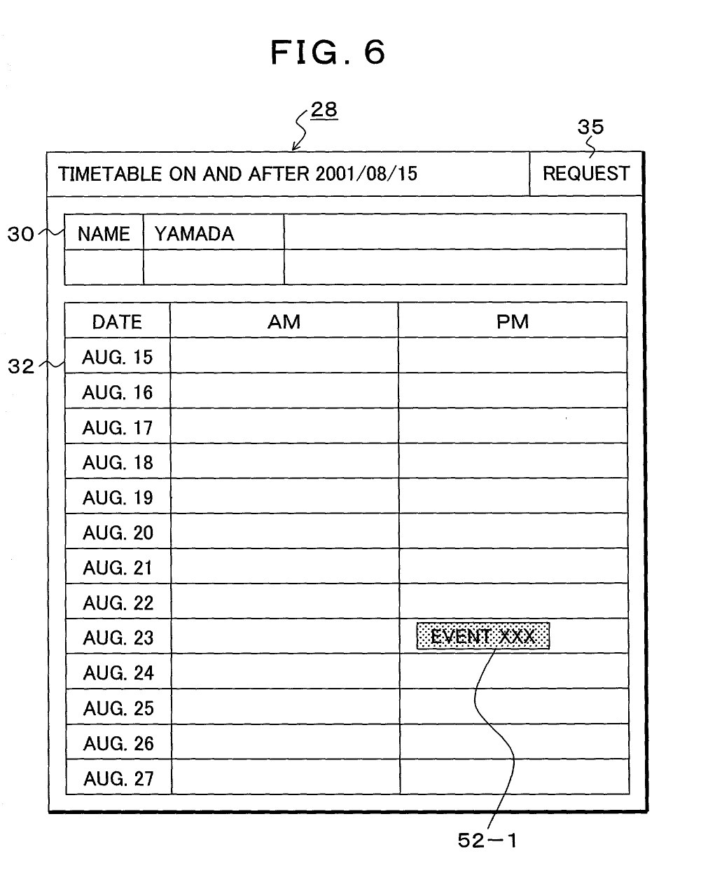

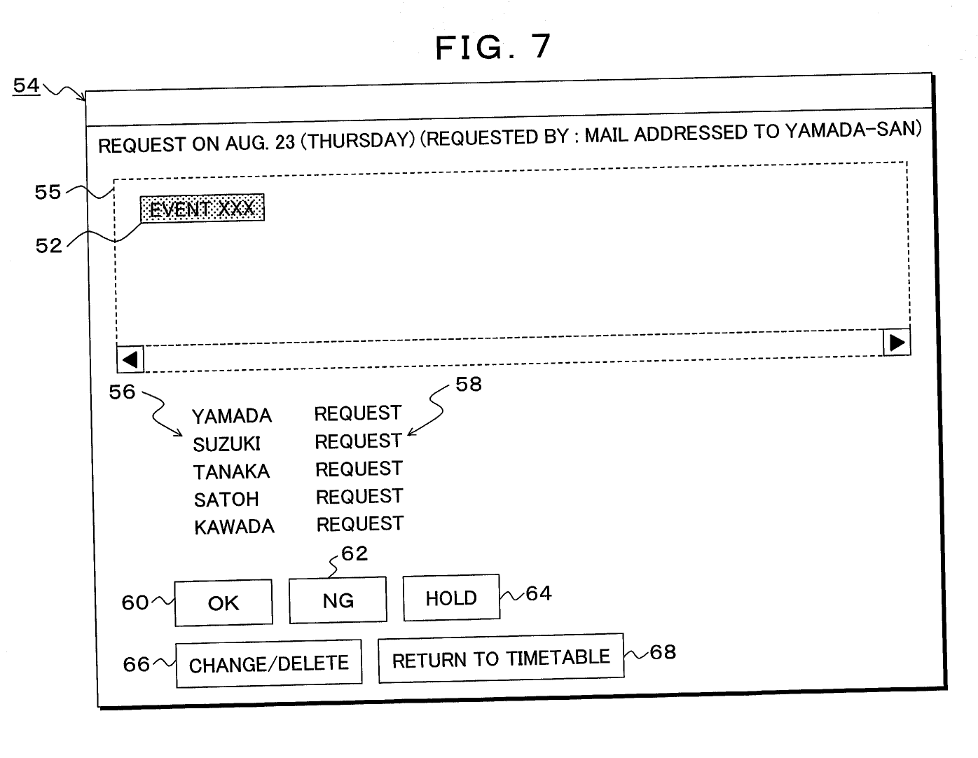

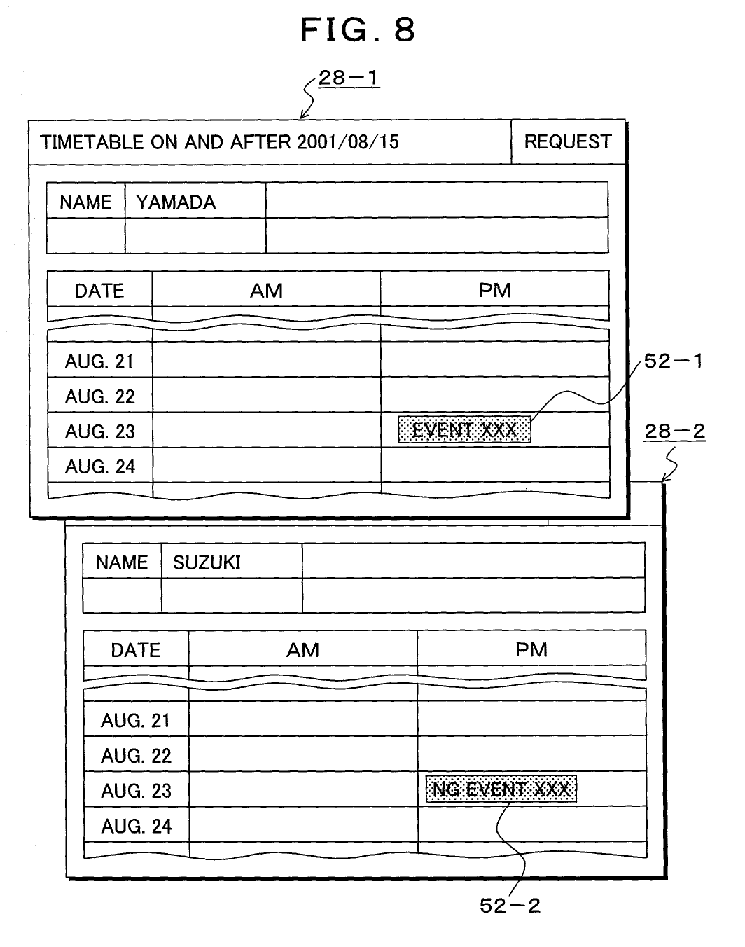

The following describes about a reply request to an attendance request. FIG. 6 shows the member schedule screen 28 of “Yamada” who made an attendance request after attendance request processing finished. On this member schedule screen 28, an event content 52-1 written in the PM field of “August 23” is displayed, by delivering of an attendance request. When the written event content 52-1 is clicked, the screen changes to a reply entry screen 54 shown in FIG. 7. On the reply entry screen 54, the requesting source is indicated as “Request on August 23 (Thursday) (Requested by: Mail addressed to Yamada-San) in the title, and under this title, an event display unit 55 is provided and the event content 52 is displayed. On the lower side of the event display unit 55, a name box 56 of the members subject to attendance request and a reply display box 58 are provided. At this point of time, if no reply arrives from any of the members who are requested to attend, reply display boxes 58 all indicate “Request”. Under the name box 56 and the reply display box 58, a present button 60 to indicate “OK”, an absent button 62 to indicate “NG”, and further a hold button 64 are provided as reply operation items for performing reply operation. Therefore, the receiver of an attendance request clicks the written event content on his own personal schedule screen, to open the reply entry screen 54 shown in FIG. 8, and clicks the present button 60, if he would attend, or clicks the absent button 62, if he would absent, or clicks the hold button 64, if he wants to hold his reply.

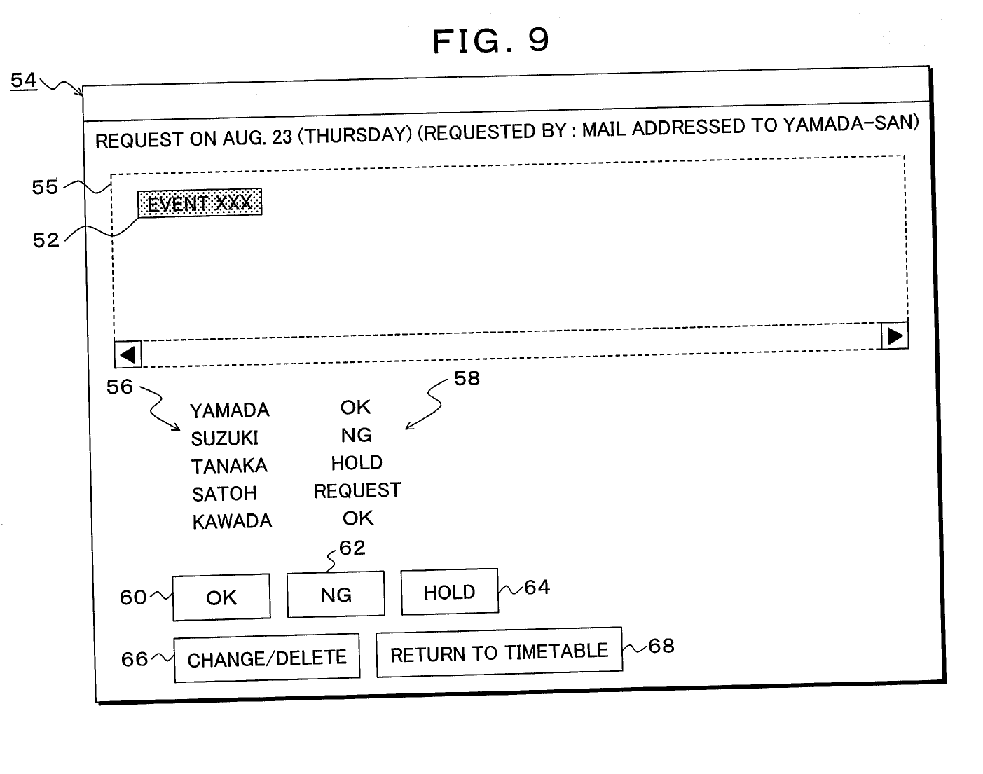

As the reply entry screen 54 shown in FIG. 9 is developed by clicking of the written event content 52-1 on the member schedule screen 28 of “Yamada” shown in FIG. 6, “Yamada” who made an attendance request would undoubtedly click the present button 60. Then, like the member schedule screen 28 of “Yamada” shown in FIG. 8, the written event content 52-1 is displayed in shading mode, because the state shown in FIG. 6 is under requesting, but, when OK reply is received, the written event content 52-1 will be clearly displayed. From this change, the scheduling table can tell that a member “Yamada” is intending to attend the event. Here, it can be programmed that instead of changing the shading display to a clear one, such a message like “OK event XXX” to be displayed. While, “Suzuki”, a member who receives an attendance request opens his own member schedule screen and clicks a written event content 52-2 instructed in his personal scheduling table, to open the reply entry screen 54 shown in FIG. 9, and if, for instance, “Suzuki” would send an NG reply, clicking the absent button 62, the scheduling table of “Suzuki” member would turn to be a member schedule screen 28-2 as shown in FIG. 9. In other words, on the member schedule screen 28-2 of “Suzuki”, member, who replied NG (absent), “NG” is attached to the head of the written event content 52-2 of his personal scheduling table 32-2, so as to indicate “absent”, and this “NG” makes it clear that “Suzuki” member would absent from an event. Furthermore, when the reply entry screen is opened by clicking of the written event content given in a personal scheduling table of a member, if the other members who receive attendance request already sent their replies, the screen will turn to be, for instance, a reply entry screen 54 as shown in FIG. 9.

If the reply entry screen 54 shown in FIG. 9 is a screen opened by, for instance, “Satoh” who receives an attendance request, and if all the members but “Satoh” already sent their replies to an attendance request, “OK” replies of “Yamada”, “Suzuki”, “Tanaka” and “Kawada” would be displayed in the reply display box 58. Because of these displayed replies, member “Satoh” can determine whether to reply “OK”, “NG” or hold, viewing the reply state of the other members who are requested to attend.

Here, the reply entry screen 54 shown in FIGS. 7 and 9 provides a change/delete button 66 and a return button 68 on the bottom side of the screen. The change/delete button 66 is to be clicked to change or delete the already processed attendance request. When the change/delete button 66 is clicked in either case of change or delete, processing to delete the already processed attendance request is performed, in other words, the written event contents 52-1 through 52-5 written in the scheduling table of the selected candidate for attendance request will be deleted. At the same time, e-mail will be automatically sent to those who are requested to attend, informing that the attendance request was changed or deleted. As to the deletion of scheduled attendance, processing will be finished by deletion from the scheduling table and automatic sending of mail, but in the case of change, the host who made an attendance request must return to the member schedule screen 28 shown in FIG. 3, clicking the return button 68, and open the attendance request entry screen 42 shown in FIG. 5, by clicking the attendance request button 35, to make an attendance request from the beginning.

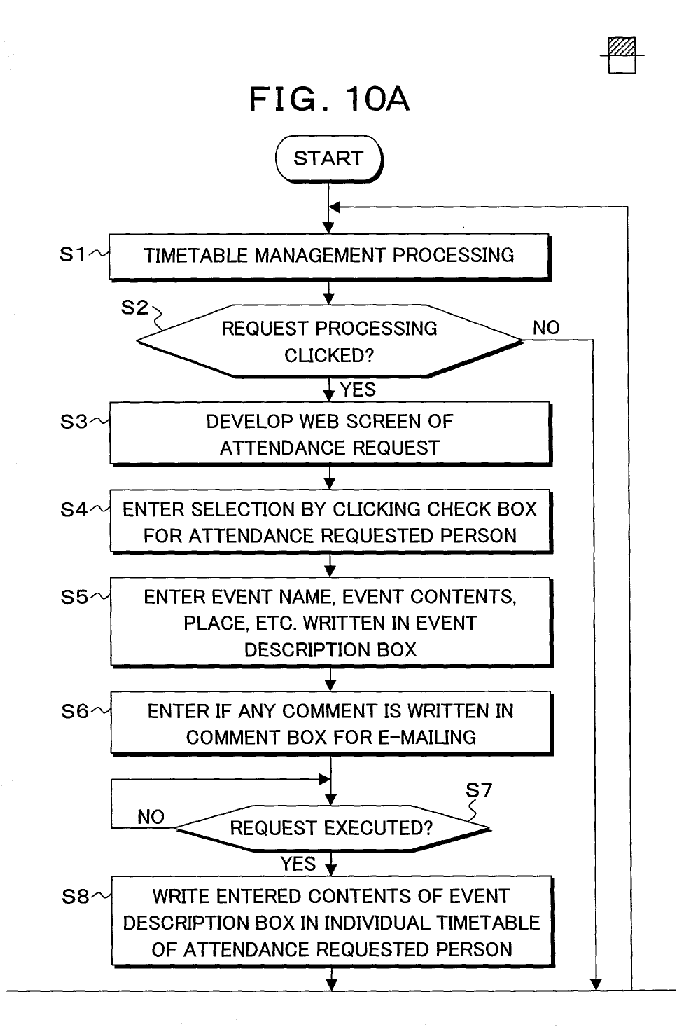

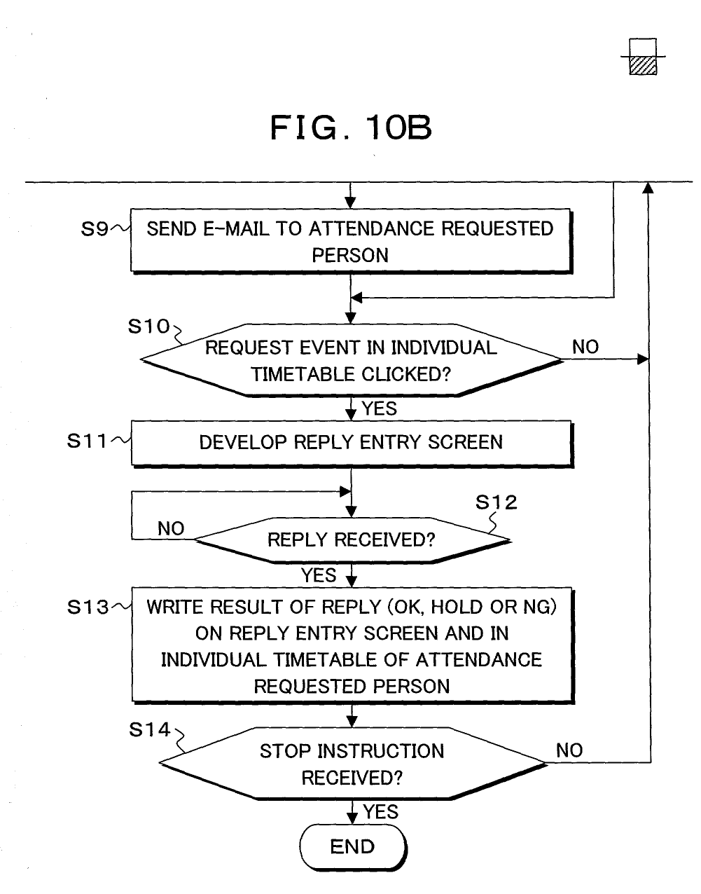

FIGS. 10A and 10B are flowcharts showing detailed schedule management processing procedure according to the present invention by the attendance request processing unit 18 installed to the Web server 12 shown in FIG. 1. These flowcharts represent an application program to embody the function of the attendance request-processing unit 18 of the Web server 12. At the step S1, the program executes management processing of the scheduling table, by schedule processing entry, to be more specific, executes input/output management of the personal scheduling table 32 by the member schedule screen 28 shown in FIG. 3, by the kick from the browser installed to the client, or executes input/output management of the scheduling table 40 on the business department schedule screen 36 shown in FIG. 4. Then, if the user demands attendance request processing, clicking the attendance request button 35 on the member schedule screen 28 shown in FIG. 3 or on the business department schedule screen 36 shown in FIG. 4, this demand is discriminated at the step S2, and at the step S3, the program allows the browser of the client to develop the Web screen, namely, the attendance entry screen. Next, at the step S4, the program enters the selection selected by clicking of the check box of the member to be requested to attend, using of the request selection box of the personal scheduling table 40 of the attendance request entry screen, and at the step S5, the program enters the written event name, event content, place, etc. in the event description box. Further, at the step S6, if necessary, the program enters the written comments of e-mail, and when receiving the request execution at the step S7 based on the input processing as described above, at the step S8, the program writes the entered content of the event description box into the personal scheduling table of the selected candidate for attendance request as the event contents. Next, at the step S9, e-mail is sent to the members to be requested to attend. When acceptance of attendance request and notification processing are finished, at the step S10, the program checks whether the client of the Web screen clicked the already written request event of the personal scheduling table. When confirming that the already written request event is clicked, the program goes on to the step S11 shown in FIG. 10B, and to the browser of the client that finished clicking of the Web screen, the program develops the reply entry screen 54 as shown in FIG. 7. When the reply from the attendance requested person using the reply entry screen 54 is judged at the step S12, at the step S13, the program writes the reply result, namely, OK denoting present, NG denoting absent or hold on the reply entry screen and in the personal scheduling table of the attendance requested person. As described above, attendance request processing including management processing of the scheduling table from the step S1 through the step S14 will be repeatedly executed until a stop instruction is given to the server machine at the step S14.

The following describes about an embodiment of a record medium storing a program for schedule management with the attendance requesting function according to the present invention. The program having the attendance requesting function in accordance with the present invention is stored in a simple record medium, like CD-ROM, floppy disk (R),DVD disk, magneto-optical disk, IC card, etc., database connected through a modem, LM interface or other lines, or stored in the database of other computer system, and executed after being installed to a computer system comprising server machines. The record medium in this case includes a database that holds the program through lines, or other computer system and a database and further a transmitting medium on line, in addition to a simple record medium, a hard disk fitted inside or outside a computer, or other record device.

Thus, according to the present invention, with the schedule management function on the Web provided by the server linked with the attendance request function to a conference or an event, an attendance request can be made, with candidates for attendance request easily selected from the scheduling table of a register type used for schedule management.

In addition, since the scheduling table of a register type can tell the day's schedule of the likely attendant, the host can properly determine to whom an attendance request is to be made, viewing the likely attendant's schedule, and the host can estimate the reply to the attendance request to a certain estimate, so that the host can effectively made an attendance request to a conference or an event.

Also, when an attendance request is made, the requested event content will be automatically written into each scheduling table of the attendance requested persons, thereby eliminating an effort to enter into the scheduling table. Further, as e-mail requesting for attendance will be automatically sent, the host does not need an effort in processing attendance requests and can securely inform each member of attendance request.

And, when a receiver of an attendance request clicks the event attendance request written in his own scheduling table, the reply entry screen will be developed, and the receiver is only required to make a reply, like OK (present), NG (absent) or hold, using the reply entry screen, and can more easily perform reply processing on the Web, compared with the case of returning e-mail in response to an attendance request.

Also, as the reply entry screen displays other attendance requested persons' replying state, the receiver of an attendance request can determine how to reply to the attendance request, viewing the screen.

Further, a host who made an attendance request can manage a series of flow from making request for attending a conference or an event, through holding a conference or an event as a single unit, so that the host can effectively make appropriate operation and management as to hold a conference or an event, even in an organization like a business department comprising a lot of members.

Here, the embodiment as described above takes a server-client system environment by an intranet of a corporate organization as an example, but in addition to this example, the present invention can be applied, for instance, to such a case, where schedule management with the attendance management function in accordance with the present invention can be applied without any modification to any system, if the system allows schedule management function to be utilized by a Web server from the browser of the client in any type of grouping organization employing membership. The present invention covers any appropriate variants without impairing the objects and advantages. Further, the present invention is not restricted by numerical values indicated in the embodiment.

What is claimed is:

1. A schedule management method comprising:
an attendance request acceptance step which includes accepting an event attendance request, by displaying an attendance request entry screen having scheduling tables in the form of a register with request selection boxes of persons requested to attend, in response to access from a user terminal;
a schedule writing step which includes writing an event attendance request in each of said scheduling tables of said persons requested to attend;
a notification step which includes notifying said persons requested to attend of said event attendance request, by sending e-mail; and
a reply acceptance step which includes accepting a reply to said event attendance request from said persons requested to attend and writing the result of said reply in each of said scheduling tables of said persons requested to attend.

2. The method according to claim 1, wherein
said attendance request entry screen displayed in said attendance request acceptance step has, in addition to said scheduling tables in the form of a register with selection boxes of persons requested to attend,
a field for specifying the date of holding an event;
a field for describing the contents of said event; and
a field for describing the text of mail.

3. The method according to claim 1, wherein
said attendance request acceptance step includes developing said scheduling tables corresponding to the entered date of holding an event.

4. The method according to claim 1, wherein
said reply acceptance step includes displaying a reply entry screen provided with reply operation items, in response to the selecting operation of an event attendance request written in each of said scheduling tables of said persons requested to attend.

5. The method according to claim 4, wherein said reply acceptance step includes providing “present”, “absent” and “hold” as said reply operation items on said reply entry screen, and allowing said replay entry screen to display the results of replay, “unreplied”, “present”, “absent” and “hold” for each of said persons requested to attend.

6. A program for schedule management, said program allowing a computer to execute:
an attendance request acceptance step which includes accepting an event attendance request, by displaying an attendance request entry screen having scheduling tables in the form of a register with request selection boxes of persons requested to attend, in response to access from a user terminal;
a schedule writing step which includes writing an event attendance request in each of said scheduling tables of said persons requested to attend;
a notification step which includes notifying said persons requested to attend of said event attendance request, by sending e-mail; and
a reply acceptance step which includes accepting a reply to said event attendance request from said persons requested to attend and writing the result of said reply in each of said scheduling tables of said persons requested to attend.

7. The program according to claim 6, wherein
said attendance request entry screen displayed in said attendance request acceptance step has, in addition to said scheduling tables in the form of a register with selection boxes of persons requested to attend,
a field for specifying the date of holding an event;
a field for describing the contents of said event; and
a field for describing the text of mail.

8. The program according to claim 6, wherein
said attendance request acceptance step includes developing said scheduling tables corresponding to the entered date of holding an event.

9. The program according to claim 6, wherein
said reply acceptance step includes displaying a reply entry screen provided with reply operation items, in response to the selecting operation of an event attendance request written in each of said scheduling tables of said persons requested to attend.

10. The program according to claim 9, wherein said reply acceptance step includes providing “present”, “absent” and “hold” as said reply operation items on said reply entry screen, and allowing said replay entry screen to display the results of replay, “unreplied”, “present”, “absent” and “hold” for each of said persons requested to attend.

11. A computer readable record medium having stored thereon a program for schedule management, said program allowing a computer to execute:
an attendance request acceptance step which includes accepting an event attendance request, by displaying an attendance request entry screen having scheduling tables in the form of a register with request selection boxes of persons requested to attend, in response to access from a user terminal;
a schedule writing step which includes writing an event attendance request in each of said scheduling tables of said persons requested to attend;
a notification step which includes notifying said persons requested to attend of said event attendance request, by sending e-mail; and
a reply acceptance step which includes accepting a reply to said event attendance request from said persons requested to attend and writing the result of said reply in each of said scheduling tables of said persons requested to attend.
